(19) United States
(12) Patent Application Publication
(10) Pub. No.: US 2006/0195728 A1
(43) Pub. Date: Aug. 31, 2006

(54) Storage unit data transmission stability detecting method and system

(75) Inventors: Wen-Hua Lin, Taipei (TW); Jian-Liang Huang, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/067,545

(22) Filed: Feb. 25, 2005

(51) Int. Cl. G06F 11/00

(52) U.S. Cl. 714/42

(57) ABSTRACT

A storage unit data transmission stability detecting method and system is proposed, which is designed for use in conjunction with a storage unit, such as a RAID (Redundant Array of Independent Disks) unit, for the purpose of detecting the data transmission stability of the RAID unit; and which is characterized by that the data transmission stability is determined based on Gaussian function on the statistics of the occurrences of a set of predefined operational conditions in data transmission. This feature allows the detected results to more precisely represent the data transmission stability of a RAID unit.

### BACKGROUND OF THE INVENTION

1. Field of the Invention

This invention relates to information technology (IT), and more particularly, to a storage unit data transmission stability detecting method and system which is designed for use in conjunction with a storage unit, such as a RAID (Redundant Array of Independent Disks) unit, for the purpose of detecting the data transmission stability of the RAID unit, and in the event of a low level of data transmission stability, capable of generating a warning message to inform system management personnel to take necessary maintenance on the RAID unit.

2. Description of Related Art

SAN (Storage Area Network) is a networking architecture which connects high-volume storage units, such as RAID (Redundant Array of Independent Disks) units, to a network system, so as to allow network servers or workstations to gain access via the network to these high-volume storage units. SAN systems typically utilize a high-speed data transmission interface, such as FC (Fibre Channel) compliant interface, for data transmission between RAID units and servers.

In SAN applications, the data transmission stability of RAID unit is an important operational attribute, i.e., high data transmission stability will ensure servers to retrieve data correctly from the RAID units, whereas low data transmission stability will cause a high probability of erroneous data being retrieved from the RAID units. For this sake, it is an important task in network management to constantly check the RAID data transmission stability of a SAN system, and in the event of low stability, take necessary maintenance on the RAID unit.

Presently, one conventional method for detecting the stability of a RAID unit is to utilize a firmware program to monitor a set of physical operational conditions, such as operating temperature, fan rotating speed, and so on, and utilize the monitored results to determine whether the RAID unit is in stable operating condition. One drawback to this method, however, is that since the detected results are related to physical operational conditions and not to data transmission, it cannot represent the stability of the data transmission between RAID units and servers in an SAN system.

### SUMMARY OF THE INVENTION

It is therefore an objective of this invention to provide a storage unit data transmission stability detecting method and system which is capable of detecting the data transmission stability of a RAID unit based on operating conditions in data transmission, so that the detected results can more precisely represent the data transmission stability of a RAID unit.

The storage unit data transmission stability detecting method and system according to the invention is designed for use in conjunction with a storage unit, such as a RAID (Redundant Array of Independent Disks) unit, for the purpose of detecting the data transmission stability of the RAID unit, and in the event of a low level of data transmission stability, capable of generating a warning message to inform system management personnel to take necessary maintenance on the RAID unit.

The storage unit data transmission stability detecting method and system according to the invention is characterized by the capability of periodically detecting whether any one of a predefined set of faulty conditions occurs during operation of the storage unit, for example including: (1) Transient Error; (2) Timeout; (3) Reset; (4) Parity Error; (5) Grown Defect; (6) Disk Error; (7) User Error; (8) Smart Value Error; and (9) Inquiry Error, and counting the total number of occurrences of each one of these faulty conditions periodically at predefined time intervals. The periodically-obtained total count of each faulty condition is then multiplied by a predefined weight to thereby obtain a weighted statistical value, and finally the weighted statistical value is compared against a reference value and a threshold value that are predefined based on Gaussian function; i.e., if the difference between the weighted statistical value and the predefined reference value is greater than the predefined threshold value, it indicates that the storage unit is instable in data transmission; and in this case, a low-stability warning message is issued to inform system management personnel to take necessary maintenance on the storage unit. Since the invention is based on a set of predefined operational conditions in data transmission, it allows the detected results to more precisely represent the data transmission stability of a RAID unit.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the application architecture and modularized object-oriented component model of the storage unit data transmission stability detecting system according to the invention.

### DETAILED DESCRIPTION OF PREFERRED EMBODIMENTS

The storage unit data transmission stability detecting method and system according to the invention is disclosed in full details by way of preferred embodiments in the following with reference to the accompanying drawing.

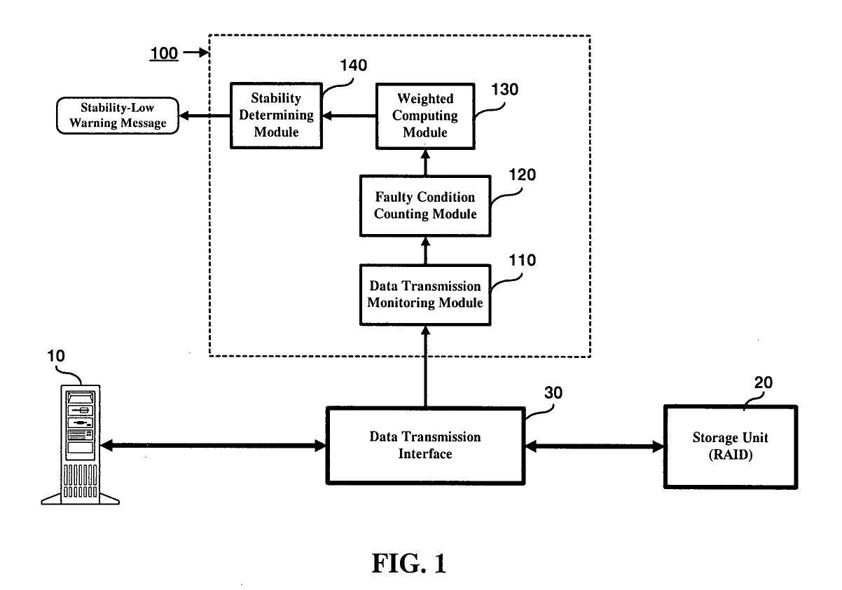

FIG. 1 is a schematic diagram showing the application architecture and modularized object-oriented component model of the storage unit data transmission stability detecting system according to the invention (as the part enclosed in the dotted box indicated by the reference numeral 100). As shown, the storage unit data transmission stability detecting system of the invention 100 is designed for use in conjunction with a data transmission interface 30 coupled between a computer unit 10 (such as a network server) and a storage unit 20 (such as a RAID unit) for detecting the stability of data transmission between the storage unit 20 and the computer unit 10. In the event of low data transmission stability, the storage unit data transmission stability detecting system of the invention 100 is capable of generating a low-stability warning message for the purpose of informing system management personnel to take necessary maintenance on the storage unit 20.

Fundamentally, the data transmission stability detected by the storage unit data transmission stability detecting system of the invention 100 is based on a predefined set of faulty conditions, including, for example, the following 9 faulty conditions: (1) Transient Error; (2) Timeout; (3) Reset; (4) Parity Error; (5) Grown Defect; (6) Disk Error; (7) User Error; (8) Smart Value Error; and (9) Inquiry Error. The storage unit data transmission stability detecting system of the invention 100 is capable of detecting the occurrences of these faulty conditions, counting the total number of occurrences of each one of these faulty conditions periodically at predefined time intervals, multiplying the periodically-obtained total count of each faulty condition by a predefined weight to thereby obtain a weighted statistical value, and finally determining whether the weighted statistical value indicates an instability condition based on Gaussian function. In the event of the data transmission stability being lowered than a predetermined standard, the storage unit data transmission stability detecting system of the invention 100 will generate a low-stability warning message for the purpose of informing system management personnel to take necessary maintenance on the storage unit 20.

In one preferred embodiment of the invention, the above-mentioned 9 faulty conditions are respectively assigned with the following weights:

| | Faulty Condition in | | |
|---|---|---|---|
| No. | Data Transmission | Assigned Weight | Variable Name |
| 1 | Transient Error | 1 | OP(1) |
| 2 | Timeout | 1 | OP(2) |
| 3 | Reset | 1 | OP(3) |
| 4 | Parity Error | 1 | OP(4) |
| 5 | Grown Defect | 2 | OP(5) |
| 6 | Disk Error | 2 | OP(6) |
| 7 | User Error | 2 | OP(7) |
| 8 | Smart Value Error | 2 | OP(8) |
| 9 | Inquiry Error | 4 | OP(9) |

In the above table, the faulty conditions (1) to (4), namely Transient Error, Timeout, Reset, and Parity Error, are regarded as minor faulty conditions, and therefore are assigned with a weight value of 1; the faulty conditions (5) to (8), namely Grown Defect, Disk Error, User Error, and Smart Value Error, are regarded as slightly serious faulty conditions, and therefore are assigned with a higher weight value of 2; and the faulty condition (9), namely Inquiry Error, is regarded as a very serious faulty condition, and therefore is assigned with the highest weight value of 4. The variables OP(1) to OP(9) are respectively used to hold the count data representative of the total number of occurrences of each one of the faulty conditions during each period.

As shown in FIG. 1, the modularized object-oriented component model of the storage unit data transmission stability detecting system of the invention 100 comprises: (a) a data transmission monitoring module 110; (b) a faulty condition counting module 120; (c) a weighted computing module 130; and (d) a stability determining module 140.

The data transmission monitoring module 110 is capable of monitoring the operating conditions of the data transmission between the storage unit 20 and the computer unit 10 during actual operation to check whether any one of a predefined set of faulty conditions occurs. In this preferred embodiment, for example, the predefined set of faulty conditions include: (1) Transient Error; (2) Timeout; (3) Reset; (4) Parity Error; (5) Grown Defect; (6) Disk Error; (7) User Error; (8) Smart Value Error; and (9) Inquiry Error. If any one of these faulty conditions occurs, the data transmission monitoring module 110 will responsively issue a corresponding count message to the faulty condition counting module 120.

The faulty condition counting module 120 is capable of responding to each count message from the data transmission monitoring module 110 to add 1 to the counted number of occurrences of each one of the predefined faulty conditions. For example, if the data transmission monitoring module 110 detects the occurrence of a transient error, the value of the corresponding variable OP(1) is increased by 1; if a timeout error is detected, the value of the corresponding variable OP(2) is increased by 1; and so forth. At the termination of each period, the faulty condition counting module 120 will reset all the variables OP(1)-OP(9) to zero.

The weighted computing module 130 is capable of performing a weighted computation procedure by multiplying the total number of occurrences of each one of the predefined faulty conditions by a predefined weight. For example, based on the data shown in the above table, the values of OP(1)-OP(9) are multiplied respectively with their assigned weights to thereby obtain a weighted statistical value F. The equation is formulated as follows:

$$F = [ \begin{matrix}1 & 2 & 1 \\ 2 & 4 & 2 \\ 1 & 2 & 1\end{matrix} ] \cdot [ \begin{matrix}OP ( 1 ) & OP ( 8 ) & OP ( 2 ) \\ OP ( 5 ) & OP ( 9 ) & OP ( 7 ) \\ OP ( 3 ) & OP ( 6 ) & OP ( 4 )\end{matrix} ]$$

The stability determining module 140 is capable of determining whether the storage unit 20 is stable or instable in data transmission by checking whether the difference between the weighted statistical value F and a predefined reference value A is greater than a predefined threshold value B; i.e., if (F−A<B), it indicates that the storage unit 20 is stable in data transmission; whereas if (F−A>B), it indicates that the storage unit 20 is instable in data transmission. In the event of (F−A>B), the stability determining module 140 will issue a low-stability warning message to inform system management personnel to take necessary maintenance on the storage unit 20. In practical implementation, for example, the reference value A and the threshold value B are predetermined based on Gaussian function.

Referring to FIG. 1, in actual operation, as the storage unit 20 is started to operate with the computer unit 10, it activates the storage unit data transmission stability detecting system of the invention 100 to periodically perform a data transmission stability detecting procedure on the data transmission between the storage unit 20 and the computer unit 10. Firstly, the data transmission monitoring module 110 is activated to monitor the storage unit 20 to check whether any one of a predefined set of faulty conditions occurs. In this embodiment, these faulty conditions include: (1) Transient Error; (2) Timeout; (3) Reset; (4) Parity Error; (5) Grown Defect; (6) Disk Error; (7) User Error; (8) Smart Value Error; and (9) Inquiry Error. If any one of these faulty conditions occurs, the data transmission monitoring module 110 will responsively issue a corresponding count message to the faulty condition counting module 120, causing the faulty condition counting module 120 to respond by adding 1 to the corresponding variable of the faulty condition. For example, if the data transmission monitoring module 110 detects the occurrence of a transient error, then the value of the corresponding variable OP(1) is increased by 1; if a timeout error is detected, the value of the corresponding variable OP(2) is increased by 1; and so forth. The faulty condition counting module 120 will transfer all the counted data, i.e., OP(1)-OP(9), to the weighted computing module 130, where a weighted computation procedure is performed on OP(1)-OP(9) to thereby obtain a weighted statistical value F by the following equation:

$$F = [ \begin{matrix}1 & 2 & 1 \\ 2 & 4 & 2 \\ 1 & 2 & 1\end{matrix} ] \cdot [ \begin{matrix}OP ( 1 ) & OP ( 8 ) & OP ( 2 ) \\ OP ( 5 ) & OP ( 9 ) & OP ( 7 ) \\ OP ( 3 ) & OP ( 6 ) & OP ( 4 )\end{matrix} ]$$

Next, the stability determining module 140 is activated to determining whether the storage unit 20 is stable or instable in data transmission by checking whether the difference between the weighted statistical value F and a predefined reference value A is greater than a predefined threshold value B; i.e., if (F−A<B), it indicates that the storage unit 20 is stable in data transmission; whereas if (F−A>B), it indicates that the storage unit 20 is instable in data transmission. In the event of (F−A>B), the stability determining module 140 issues a low-stability warning message so as to inform system management personnel to take necessary maintenance on the storage unit 20. The low-stability warning message is presented in a human-perceivable form, such as displayed in text form on a computer screen (not shown).

In conclusion, the invention provides a storage unit data transmission stability detecting method and system for use with a data transmission interface coupled between a computer unit and a storage unit for detecting the stability of data transmission between the storage unit and the computer unit, and which is characterized by the capability of periodically detecting whether any one of a predefined set of faulty conditions occurs during operation of the storage unit, and counting the total number of occurrences of each one of these faulty conditions periodically at predefined time intervals. The periodically obtained total count of each faulty condition is then multiplied by a predefined weight to thereby obtain a weighted statistical value, and finally the weighted statistical value is compared against a reference value and a threshold value based on Gaussian function; i.e., if the difference between the weighted statistical value and the predefined reference value is greater than the predefined threshold value, it indicates that the storage unit is instable in data transmission; and in this case, a low-stability warning message is issued to inform system management personnel to take necessary maintenance on the storage unit. Since the invention is based on a set of predefined operational conditions in data transmission, it allows the detected results to more precisely represent the data transmission stability of a RAID unit. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A storage unit data transmission stability detecting method use on a data transmission interface coupled between a computer unit and a storage unit for detecting the stability of data transmission between the storage unit and the computer unit;
the storage unit data transmission stability detecting method comprising:
monitoring the storage unit during actual operation to check whether one of a predefined set of faulty conditions occurs; if YES, issuing a corresponding count message;
responding to each count message to count the total number of occurrences of each one of the predefined faulty conditions periodically during predefined time intervals;
performing a weighted computation procedure by multiplying the total counted number of occurrences of each one of the predefined faulty conditions by a predefined weight to thereby obtain a weighted statistical value;
predefining a reference value and a threshold value based on Gaussian function; and
checking whether the difference between the weighted statistical value and the predefined reference value is greater than the predefined threshold value; if YES, issuing a low-stability warning message.

2. The storage unit data transmission stability detecting method of claim 1, wherein the computer unit is a network server.

3. The storage unit data transmission stability detecting method of claim 1, wherein the storage unit is a RAID (Redundant Array of Independent Disks) unit.

4. A storage unit data transmission stability detecting system for use with a data transmission interface coupled between a computer unit and a storage unit for detecting the stability of data transmission between the storage unit and the computer unit;
the storage unit data transmission stability detecting system comprising:
a data transmission monitoring module, which is capable of monitoring the storage unit during actual operation to check whether one of a predefined set of faulty conditions occurs; if YES, capable of issuing a corresponding count message;
a faulty condition counting module, which is capable of responding to each count message from the data transmission monitoring module to count the total number of occurrences of each one of the predefined faulty conditions periodically during predefined time intervals;
a weighted computing module, which is capable of performing a weighted computation procedure by multiplying the total counted number of occurrences of each one of the predefined faulty conditions by a predefined weight to thereby obtain a weighted statistical value; and
a stability determining module, which is capable of determining whether the storage unit is instable in data transmission by checking whether the difference between the weighted statistical value and a predefined reference value is greater than a predefined threshold value, where the reference value and the threshold value are predefined based on Gaussian function; if YES, capable of issuing a low-stability warning message.

5. The storage unit data transmission stability detecting system of claim 4, wherein the computer unit is a network server.

6. The storage unit data transmission stability detecting system of claim 4, wherein the storage unit is a RAID (Redundant Array of Independent Disks) unit.
